(19) United States
(12) Patent Application Publication
(10) Pub. No.: US 2003/0050744 A1
(43) Pub. Date: Mar. 13, 2003

(54) Electronic sign for information equipped for satellite positioning system on passenger transportation vehicle

(76) Inventor: Pablo Salle Saraiva, La Teste (FR)

Correspondence Address: Richard C. Litman, LITMAN LAW OFFICES, LTD., P.O. Box 15035, Arlington, VA, 22215, US

(21) Appl. No.: 10/235,510

(22) Filed: Sep. 6, 2002

Related U.S. Application Data
(60) Provisional application No. 60/317,490, filed on Sep. 7, 2001.

(51) Int. Cl. G06F 17/00

(52) U.S. Cl. 701/1; 340/425.5

(57) ABSTRACT

A system which includes an electronic sign located in a vehicle of a passenger transportation system with the capability of showing letters, numbers and graphs. The electronic sign is equipped with a satellite based positioning system which enables specific information uploading for a particular geographical region for displaying information, news, publicity, advertisement, and services for the passenger. The electronic sign capability of determining its position allows it to locate the appropriate “uploading sites,” which automatically update information for the geographic position where the information should be addressed for any number of signs located in that geographic position. This makes it simple to advertise or inform the nearby population in a previously chosen target region.

### CROSS-REFERENCE TO RELATED APPLICATION

This application claims the benefit of U.S. Provisional Patent Application Serial No. 60/317,490, filed Sep. 7, 2001.

### BACKGROUND OF THE INVENTION

1. Field of the Invention

The present invention relates to electronic displays for use in vehicles. More particularly, the present invention relates to an electronic display sign and screen which is updated by radio transmitters according to its location as determined by a satellite positioning system located within the vehicle.

2. Description of Related Art

Electronic signs located in passenger vehicles with the capability of being uploaded from a computer or from an infrared remote control are known. They were built for delivering individual messages, but they are not equipped with satellite positioning systems, therefore, they cannot be geographically positioned. It would be desirable to have a vehicle system in a transportation system which may be updated according to its position, may deliver visual media for passengers, have capability to pass update information between similarly equipped vehicles, even in case an obstacle occurs, i.e., satellites are not visible for vehicle positioning.

U.S. Pat. No. 5,627,549, issued May 6, 1997 to Park describes a vehicle information device equipped with a GPS receiver and a radio receiver. The device receives advertisements and map information over the radio. It displays this information to the user but also stores it so that the user can access it in greater detail at a later time. The device receives data transmission from a station relating to an advertisement as heard on the vehicle radio and calculates and displays directions to the advertiser.

U.S. Pat. No. 6,185,501 B1, issued Feb. 6, 2001, to Smith et al. describes a system in which navigation information, advertisements, and messages specific to the occupants of a vehicle are delivered to an information device inside the vehicle. The delivery of this information occurs while the vehicle is at a gas station, rest stop, or tourist center.

U.S. Pat. No. 6,154,689, issued Nov. 28, 2000, to Pereira et al. describes a multimedia system equipped with a GPS Receiver for use in vehicles. Based on the geographic position of the vehicle, the device displays entertainment programs or travel information.

Uruguayan Patent No. 13,742, published Aug. 8, 1997 and granted Nov. 15, 1999, to Salle Saraiva, the present inventor, is related to the present invention and describes an electronic sign system over which the present invention is an improvement.

None of the above inventions and patents, taken either singly or in combination, is seen to describe the instant invention as claimed.

### SUMMARY OF THE INVENTION

The present invention is a system which includes an electronic sign located in a passenger vehicle or each of a fleet of vehicles, such as a city bus system, with the capability of showing letters, numbers and graphs to a passengers such as the public traveling on the bus system. The electronic sign is equipped with a satellite based positioning system which enables specific information uploading for a particular geographical region for displaying relevant information, news, publicity, advertisement, and services for the passenger. The electronic sign capability of determining its position allows it to locate the appropriate “uploading sites,” which automatically update information relevant for the geographic position where the information should be addressed for any number of signs located in that geographic position. Besides, the electronic sign has the capability of changing information versus time for a set geographic position. This makes it simple to advertise or inform the nearby population in a previously chosen target region.

Any electronic sign located within the transmitter zone reach can be uploaded through radio frequency with a low power transmitter, avoiding the high cost of a medium power transmitter as well as resultant radio frequency pollution. The only units uploaded are the ones located within the transmitter reach and programmed to receive its data at that position. The inventive system allows the delivery of selected publicity from the electronic sign screen to consumers, since the advertisement can be changed according to the geographic position of the unit. The inventive system also allows for the release of information(such as news headlines, game scores, etc.) because each sign can be uploaded at any time. The inventive system also allows the release of information related to the passenger's immediate interest, such as next stop, exact time, and so forth.

The system in the passenger vehicle includes an electronic sign with an electronic screen, central processing unit, data memory, radio receiver, and satellite positioning system unit. It also includes a radio transmitter operating at the same frequency as the transmitters at uploading sites and running with spread spectrum but different noise code (diphase modulation) in comparison to the transmitters at uploading sites. For a number of vehicles having the inventive system, their signs are time synchronized by the satellite positioning system receiver. Thus, a dialog time can be associated to each electronic sign in a way that one sign can receive new information from another sign in another vehicle, eliminating the need of being close to an uploading site. In this manner a communication network is established within a vehicle fleet equipped with the electronic sign system and the uploading site.

The uploading site includes a modem, a central processing unit, a data memory, a transmitter with radio frequency operating at spread spectrum, but noise code(diphase modulation) different from the transmitters located on the electronic signs described above, and a positioning satellite system receiver. Transmitters of uploading sites are synchronized by satellite positioning system receivers, so that transmitters can be utilized for a position calculation system which are needed in the case of a hidden satellite situation or occurrence of reflected signals due to occasional obstructions during the vehicle trajectory related to its geographical position, thus substituting the hidden satellite for position calculation.

Each electronic sign has two operational modes: a mode for information on screen, and a mode for uploading.

In the information on screen mode, the electronic sign central processing unit(CPU) determines its position using its internal satellite positioning system receiver. Thus, according to its position, it automatically runs messages stored in its data memory such as publicity, advertisements, news, next vehicle stop and so forth. Within this mode, an electronic sign installed on a vehicle has the ability of communicating through radio frequency(utilizing its transmitter and receiver) with other vehicles(through their signs) located in its proximity and synchronized with their respective satellite positioning system receivers installed on each vehicle. Their communication becomes automatically synchronized and, in this way, new information can be interchanged at will. Also, information update becomes instantaneous, since there is no need for a vehicle to approach an uploading zone to be uploaded. All vehicles have the ability to upload each other with updated information, forming a communication network within the vehicle fleet. Therefore, there is no need of multiple uploading zones for information update.

Whenever the central processing unit of an electronic sign detects, through its positioning satellite system receiver, that it is within the reach of an uploading zone, it automatically switches to uploading mode. Newly received information is automatically stored in its data memory. Information is updated whenever an electronic sign is located within an uploading site reach.

The uploading site is connected through telephone line to upload new data to be processed by electronic signs. Through a modem connected to the telephone line, a microprocessor receives and stores data in its memory. The communication automatically ends after data are transferred, allowing data to be automatically resent to the transmitter. These data are thereby sent to and received by every electronic sign equipped with a satellite positioning system receiver which is located within the uploading zone.

The transmitter and the satellite positioning system receiver of the uploading site are synchronized, and are accurately located, allowing their utilization for calculating a vehicle position in a site where uploads are received, but not enough satellites are in line of sight.

Accordingly, it is a principal object of the invention to provide an electronic sign for displaying information on transportation systems such as a fleet of vehicles which utilizes a satellite position unit in combination with dynamic signs, creating an environment of great versatility for the dissemination of information, publicity, advertisement and services.

It is another object of the invention to provide an electronic sign system as above which is uploaded utilizing a satellite positioning system unit that allows sending and changing of data from fixed sites.

It is a further object of the invention to provide an electronic sign system as above having the ability to change displayed data at will, according to the vehicle geographical location as obtained through its satellite positioning system receiver.

Still another object of the invention is to provide an electronic sign system as above which utilizes transmitters synchronized with the vehicle satellite positioning system receiver for calculating its position, thus, substituting the satellite in case an obstacle occurs between the electronic sign satellite positioning receiver antenna and the satellite or reflected signals are received, allowing the system to change display information automatically according to the vehicle's geographical location by means of its satellite positioning system receiver.

It is yet another object of the invention to provide an electronic sign system as above wherein the transmitters in the vehicles are synchronized with the satellite positioning system receiver of a vehicle's electronic sign so that information may be interchanged with all remaining vehicles, thus increasing their capability to update information when outside the reach of an uploading site.

It is an object of the invention to provide improved elements and arrangements thereof in apparatuses for the purposes described which is dependable and fully effective in accomplishing their intended purposes.

These and other objects of the present invention will become readily apparent upon further review of the following specification and drawings.

### BRIEF DESCRIPTION OF THE DRAWINGS

FIG. 1 is a diagrammatic representation of the electronic sign system for vehicles according to the present invention.

FIG. 2 is a diagrammatic representation of the electronic sign system of FIG. 1 illustrating communication between signs in separate vehicles, a satellite, and a fixed upload station.

FIG. 3 is a diagrammatic representation similar to that of FIG. 2 with the addition of fixed retransmission base sites for use in obstacle rich environments such as cities.

Similar reference characters denote corresponding features consistently throughout the attached drawings.

### DETAILED DESCRIPTION OF THE PREFERRED EMBODIMENT

The present invention includes an electronic sign located in a passenger vehicle with the capability of showing letters, numbers and graphs. The electronic sign is equipped with a satellite positioning system which enables easy uploading and providing capability for displaying relevant information, news, publicity, advertisement, and services for the passenger. The electronic sign capability of determining its position allows it to locate “uploading sites.” These sites automatically update any number of signs within a geographic region with information intended for signs in that geographic region. This makes it simple to advertise or inform the nearby population in a previously chosen region.

The system in the passenger vehicle includes an electronic sign with a central processing unit, data memory, radio receiver, and satellite positioning system unit. It also includes a radio transmitter operating at the same frequency as the transmitters at uploading sites and running with spread spectrum but different noise code(diphase modulation) in comparison to the transmitters at uploading sites. For a number of vehicles having the inventive system, their signs are time synchronized by the satellite positioning system receiver. Thus, a dialog time can be associated to each electronic sign in a way that one sign can receive new information from another sign in another vehicle, eliminating the need of being close to an uploading site. In this manner a communication network is established within a vehicle fleet equipped with the electronic sign system and the uploading site.

The uploading site is connected through telephone line to upload new data to be processed by electronic signs. Through a modem connected to the telephone line, a microprocessor receives and stores data in its memory. The communication automatically ends after data are transferred, allowing data to be automatically resent to the transmitter. These data are thereby sent and received by every electronic sign equipped with satellite positioning system receiver located within the uploading zone.

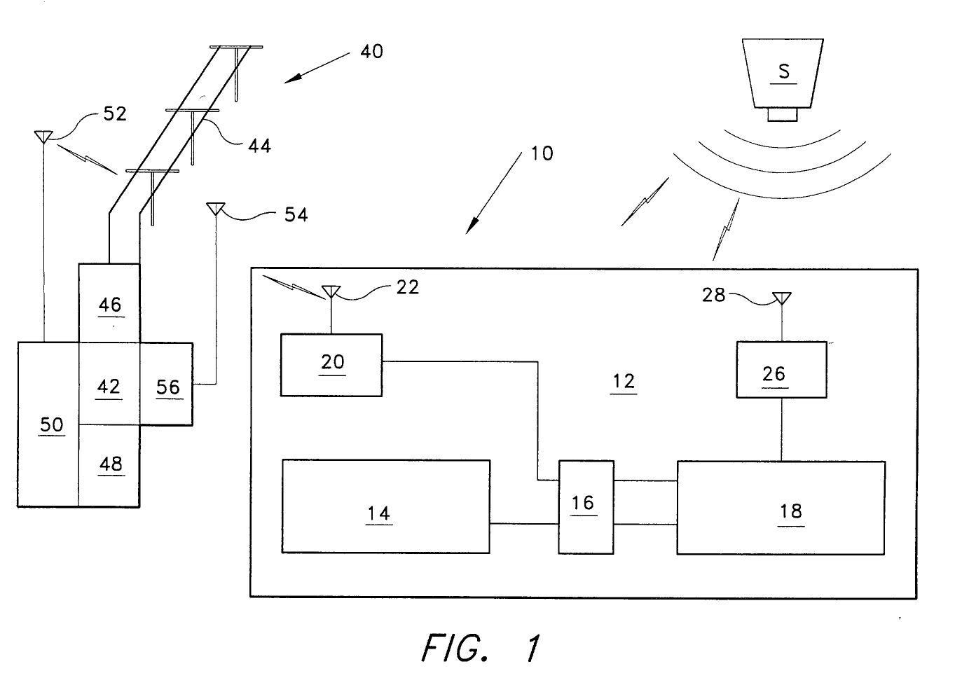

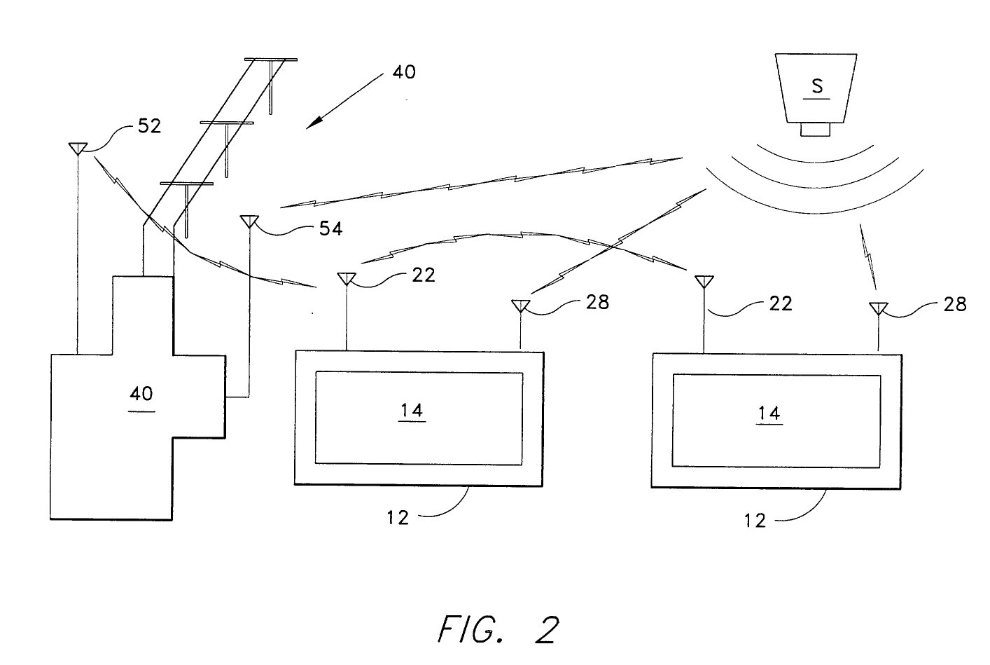

Referring to FIGS. 1 and 2, there are shown diagrammatic representations of the inventive electronic sign system 10. Sign system 10 includes vehicle mounted sign 12 having an electronic screen 14, a central processing unit(CPU) 16, a data memory 18, a radio frequency receiver/transmitter 20, an antenna 22 for reception and sending of radio frequency signals, and a satellite positioning receiver 26 having satellite receiver antenna 28 for receiving positioning data from satellite S.

Electronic sign system 10 also includes fixed uploading site 40, having fixed site CPU 42, telephone line 44, fixed uploading site telephone communication modem 46, fixed uploading site data memory 48, fixed uploading site radio transmitter 50, antenna 52 for transmitting radio frequency signals to said vehicle antenna 22, and satellite receiver antenna 54 and satellite positioning receiver 56 for receiving positioning satellite data from satellite S.

As seen in FIG. 2, two signs 12, having electronic screens 14, and mounted on two vehicles(not shown), have transmitter/receiver antenna 22, and satellite positioning system receiver antenna 28. Radio transmitter 20 and antenna 22 (see FIG. 1) operate at the same frequency as the transmitters 50 and antenna 52 at uploading sites 40, operating with spread spectrum, but with different noise code (diphase modulation) in comparison to the transmitters 50 at uploading sites. Synchronization of each electronic sign 12 is effected via their respective satellite positioning system antennae 28, i.e., all electronic signs are synchronized. Thus, a dialog time can be associated with each electronic sign 12 in a known manner such that one sign may receive new information from another via their respective transmitter/receiver antenna 22, eliminating the need of all signs being close to an uploading site. A communication network is thereby established within the vehicle fleet equipped with the vehicle mounted signs 12 as well as with their uploading site 40.

The uploading site 40 includes transmitter 50 with radio frequency operating at expanded spectrum but noise code(diphase modulation) different from the transmitters located on the electronic signs. Uploading site 40 also includes a positioning satellite system receiver 56. Transmitters 50 of uploading sites 40 are synchronized with satellite position system receivers 12 of vehicle mounted signs so that transmitters can be utilized for a position calculation system (not shown). This position calculation system is used in the case of hidden satellite situations or occurrence of reflected signals due to occasional obstructions during the vehicle trajectory related to its geographical position as further explained below.

In operation, each electronic sign has two operational modes. During the operational mode for information on screen, the electronic sign CPU 16 determines its position using data from the internal satellite position system receiver 26. Then, according to its position, it automatically runs messages stored in its data memory 18 such as publicity, advertisements, news, next vehicle stop, etc.

Within this mode, an electronic sign 12 installed on a vehicle has the ability of communicating through radio frequency signal (utilizing its receiver/transmitter 20) with other vehicles (through their electronic signs 12) located in its proximity and synchronized by means of their respective satellite positioning system receiver 26 as installed in both vehicles. Their communication is automatically synchronized and, in this way, new information can be interchanged at will. Also, information update becomes instantaneous, since there is no need for a vehicle to approach an uploading site to be uploaded. All vehicles have the ability to upload each other with updated information, forming a communication network within the vehicle fleet. Therefore, there is no need of multiple uploading sites for information update.

Whenever the electronic sign CPU 16 detects, through its positioning satellite system receiver 26, that it is within the reach of an uploading site 40, it automatically switches to uploading mode. Newly received data is automatically stored in its data memory 18. Data is updated whenever an electronic sign 12 is located within an uploading site reach.

The uploading site 40 is connected with telephone line 44 to upload new data to be processed by electronic signs 12 by means of a modem 46 connected to the telephone line 44. The data is then received by a data processing CPU 42 and stored in fixed site data memory 48. This communication automatically ends after data are transferred, allowing data to be automatically resent to the fixed site radio transmitter 50. These data are sent and received by every electronic sign 12 within the uploading zone.

The transmitter 50 and the satellite positioning system receiver 56 of the uploading site 40 are synchronized with each other, and are accurately located, allowing their utilization for calculating a vehicle position in a zone where uploads are received, but insufficient satellites are in the vehicle line of sight.

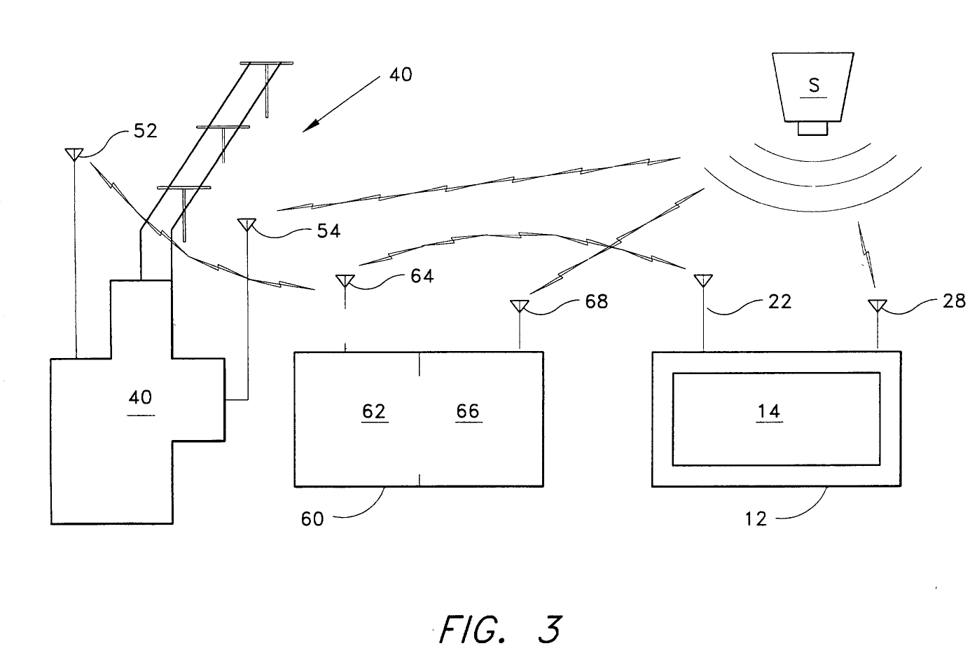

Referring to FIG. 3, there is shown a system similar to that of FIG. 1 with the addition of fixed ground transmitter sites 60. Sites 60 include radio receiver/transmitter 62 having receiver/transmitter antenna 64, and satellite positioning system receiver 66 having antenna 68. Sites 60 are useful in obstacle rich environments as explained below. They have a known fixed location and incorporate a ground radio receiver/transmitter 62 with receiver/transmitter antenna 64 and a satellite positioning system receiver 66 having antenna 68. Ground radio transmitter 62 and satellite positioning receiver 66 are synchronized with each other. They assume the function of a satellite which may not be in the direct view of the vehicle sign 12 to assist in determining the location of the vehicle sign. With the addition of a radio receiver, a central processing unit, a data memory, and a modem connected to a telephone line (none of these shown), they become capable to retransmit upload information as an uploading site.

The system functions based upon utilization of a satellite group, where satellites emit modulated (phase) carrier signals. The phase of satellite signals is synchronized through atomic clocks. Each signal is modulated (phase) by noise code (PRN) resulting in a spread-spectrum signal. The receiver position is calculated through the difference in phase of signals from satellites to receiver (calculation by code). The measurement of the difference in phase of satellite signals determines the difference in distance traveled by the signals, which is (in first approach) proportional to the difference of distances between the receiver and the satellites. The antenna receiver position is determined by mathematics calculation in a known manner, utilizing the known satellites' positions.

Problems to overcome in practice include the fact that positioning satellite receivers malfunction in an urban environment in those cases where obstacles are present between their antennae and the satellites. Three visible satellites are needed for calculating the receiver position. In the case where the receiver is located in a zone within obstacles (buildings for instance) the required number of satellites may not be visible, or signals from the satellites might be reflected, therefore introducing error.

A solution to overcome the above-mentioned problems according to the present invention includes the utilization of ground transmitters 60 as a substitute for satellites that are not in view of the receiver vehicle. The transmitter at an upload site may act as one transmitter as mentioned above. The utilization of a ground transmitter clock, synchronized with the satellites' clocks insure the satellites' clock precision-relative to the transmitter clock. Transmitters are strategically located within all critical zones of reception. The transmitters may also be utilized as digital data retransmission bases for information updating. For each retransmission base, one satellite receiver is installed, capable of synchronizing its clock with that of the satellites. Each base location (coordinates) has been accurately positioned and is known. The utilization of a noise code different from the noise code utilized by the satellite system allows the identification of a signal transmission received from a ground transmitter. By this means, the transmitter emits its position within the spread spectrum, utilizing PRN code in the manner of the satellites. Also, the transmitter emits its carrier signal synchronized with the satellites. This procedure allows a receiver located within the transmitter range to recognize the transmitter through its PRN code and to calculate the receiver's position utilizing the base as an additional satellite.

### EXAMPLE

For utilization in a public transportation system in an urban environment, the electronic system comprises a central office, fixed uploading sites and electronic signs installed on buses, and transmitter bases.

The central office is equipped with a PC, and modem connected to a telephone line.

Fixed uploading sites are equipped with radio receiver/transmitter, modem connected to telephone line, CPU, data memory and satellite positioning receiver, and may be located at bus terminals.

Electronic signs installed on buses are equipped with electronic screen, CPU, data memory, radio receiver/transmitter, and satellite positioning receiver.

Transmitter bases are equipped with satellite positioning receiver and radio transmitter, and strategically located for calculating electronic sign(bus) position as a substitute for satellites in the case where obstacles(buildings) are present between the electronic sign satellite positioning receiver antenna and the satellites. Such bases may be installed in addition to a fixed uploading site. A retransmission base may optionally be furnished with additional equipment to have uploading site features added to it (additional equipment identical to that of an uploading site).

An uploading site is connected to the central office through a telephone line to upload new data to be processed by electronic signs, which release advertisement, publicity, news, and information through their electronic screens. An advertisement is delivered to bus passengers according to the bus position, i.e., an advertisement for a business nearby the bus position is delivered to passengers whenever the bus approaches the business location. By these means, a large number of advertisements combined with new and information can be delivered to bus passengers. The electronic screen becomes an entertainment to bus passengers and the advertisement becomes affordable for small business.

An electronic sign has means for precisely determining its specific uploading site for receiving its specific data, whether there is another uploading site nearby or not. As an example, two uploading sites located in the same bus terminal for delivering different data to two different bus lines, respectively.

An electronic sign mounted on a bus also has means for uploading another similar sign, and recognizes all signs where upload is addressed. This capability is useful, for example, in the situation where new information should be interchanged among buses of the same line only. Therefore, buses of different lines equipped with signs will not interchange information, even if they approach on another. In this manner, according to this example, buses of the same line can upload new information among them outside the reach of an uploading site, thus allowing faster information update, and forming a communication network within buses of the same line equipped with electronic signs for viewing by members of the public traveling on the buses.

It is to be understood that the present invention is not limited to the sole embodiment described above, but encompasses any and all embodiments within the scope of the following claims.

I claim:

1. An electronic sign for installation in a passenger vehicle comprising:
a radio receiver;
a satellite positioning system unit;
a central processing unit;
a data memory;
an electronic screen; and
a radio receiver/transmitter;
whereby said radio receiver receives a particular update signal as determined by said satellite positioning system unit, said signal being processed by said central processing unit and stored in said data memory for updating said data memory;
whereby said data memory provides updated information to said electronic screen for presentation thereon; and
whereby said data memory provides updated information to said radio transmitter, and thus said radio transmitter, for transmitting said update signal.

2. A system for providing updated information to a passenger vehicle comprising:
an uploading site having means for transmitting an update radio signal;
at least a first and a second vehicle mounted electronic sign, each said sign having:
means for receiving an update radio signal;
means for storing update signals to form an updated database;
means to display said updated database; and
means to transmit said updated database as a radio signal;
whereby at least one of said first vehicle mounted electronic signs receives said update signal from said uploading site; and
whereby at least one of said second vehicle mounted electronic signs receives said updated database radio signal from said at least one first electronic sign.

3. A method of providing updated information to the public in at least first and second vehicles comprising;
providing an uploading site having means for transmitting an update radio signal;
providing at least a first and a second electronic sign corresponding to said first and second vehicles,
each said sign having:
means for receiving an update radio signal;
means to display said updated database to a vehicle passenger; and
means to transmit said updated database as a radio signal;
said uploading site sending an upload radio signal to said at least first electronic sign;
said at least first electronic sign displaying data to said passengers in said first vehicle received from said uploading site by means of said upload radio signal;
said at least first electronic sign sending an upload radio signal to said at least second electronic sign; and
said at least second electronic sign storing the same data stored on said at least first electronic sign to said passengers in said second vehicle according to said at least second electronic sign position.

4. An electronic sign for information located on a vehicle of passenger transportation systems utilizing a satellite positioning system receiver in combination with a dynamic electronic sign, said sign for installation in a said vehicle of a said passenger transportation system comprising:
a satellite positioning system receiver;
a central processing unit;
a data memory;
an electronic screen; and
a radio receiver/transmitter;
whereby the installation of said satellite positioning system receiver combined with said dynamic electronic sign on said passenger transportation system unit creates an environment of great versatility for information, publicity, advertisement and services;
whereby said central processing unit, utilizing said radio receiver/transmitter, receives data through a radio frequency signal from a specific fixed uploading site;
whereby said fixed uploading site is accurately located by said satellite positioning system receiver.
whereby said central processing unit, utilizing said radio receiver/transmitter may receive data through radio frequency signal from another identical electronic sign mounted in another vehicle;
whereby said radio receiver/transmitter of said sign and said radio receiver/transmitter of said another identical electronic sign mounted in another vehicle run spread-spectrum with the same noise code;
whereby the entire electronic sign system is synchronized with said satellite positioning system;
said fixed uploading site comprising:
a modem connected to a telephone line;
a satellite positioning system receiver;
a central processing unit;
a data memory;
a radio receiver/transmitter;
means for receiving new information through said modem;
means for processing said new information by its said central processing unit; and
means for storing said new information in its said data memory;
whereby said new information received through radio frequency by said central processing unit of said electronic sign is verified and stored in said data memory of said electronic sign;
whereby said new information updates existing data stored at said data memory of said electronic sign;
whereby said updated data stored in said data memory of said electronic sign have the information to be displayed at said electronic screen and the coordinates(longitude, latitude) of where said information should be displayed;
whereby said central processing unit of said electronic sign receives said coordinates(longitude, latitude) from said satellite positioning system receiver of said electronic sign; and
whereby, according to said coordinates (latitude, longitude) and said data stored in said data memory, said central processing unit updates information to be displayed at said electronic screen;
thus creating an environment of great versatility for information, publicity, advertisement and services.

5. The electronic sign of claim 4, further comprising means for changing information versus time at the same geographic position.

6. A system for providing updated information to a vehicle of a passenger transportation system, according to claim 5, comprising:
a fixed uploading site;
at least one vehicle mounted electronic sign;
said fixed uploading site having:
means for transmitting updated information, through a radio signal, to said at least one vehicle mounted electronic sign;
said at least one vehicle mounted electronic sign having:
means for locating the position of said fixed uploading site through said satellite positioning system receiver of said at least one vehicle mounted sign;
means for receiving a radio signal from said fixed uploading site; and
means for storing updated information in said data memory of said at least one vehicle mounted electronic sign.

7. A system for providing updated information to a vehicle of a passenger transportation system according to claim 6, comprising;
at least one vehicle mounted electronic sign, said sign having;
means for locating its position through its satellite position receiver; and
means to display updated information according to the said sign position.

8. The system of claim 7, further comprising at least one fixed ground retransmission base for installation in an obstacle rich environment comprising;
a satellite position system receiver;
a radio receiver/transmitter;
a central processing unit;
a modem connected to a telephone line;
a data memory;
means for maintaining synchronization with satellites through said satellite positioning receiver of the said retransmission base;
means for determining the position of at least one vehicle mounted electronic sign through signals emitted from said radio transmitter of said retransmission base and received by said radio receiver/transmitter of said vehicle mounted electronic sign;
whereby the location of said electronic sign is determined in case and obstacle occurs between said electronic sign and a satellite rendering the number of satellites insufficient for said electronic sign position calculation;
whereby said retransmission base utilizes noise code different from the noise code utilized by the satellite positioning system, allowing said radio receiver/transmitter of said electronic sign to recognize transmissions received from said radio transmitter of said retransmission base;
whereby the position(coordinates) of said retransmission base is accurately known;
whereby said radio receiver/transmitter of said retransmission base emits its position within spread-spectrum utilizing PRN code in the manner of the satellites and emits its carrier signal synchronized with said satellites; and
whereby allowing said radio receiver of said electronic sign, located within the said radio transmitter range of said base, to recognize the said transmitter through its PRN code and to calculate the radio receiver position utilizing said base as an additional satellite.

9. The system of claim 8, further comprising means for updating said data memory of said retransmission base through said modem connected to said telephone line of said retransmission base.

10. A method of employing the system of claim 9 to provide updated information to the public in at least first and second vehicles comprising the steps of:
providing a fixed uploading site;
providing at least a first and second electronic sign corresponding to said first and second vehicle;
transmitting updated information by radio signal from said fixed uploading site;
said sign receiving updated information through radio signal;
said sign displaying updated information in its electronic screen;
said sign transmitting said updated information through radio signal synchronized with its satellite positioning system receiver;
sending updated information from said fixed uploading site, through radio signal, to said at least first electronic sign;
said at least first electronic sign displaying in its electronic screen information to said first vehicle according to the said at least first vehicle position;
said at least first electronic sign uploading by radio signal the said second electric sign with information stored in the said first sign memory;
said at least second electronic sign storing said information in its data memory;
said at least second electronic sign displaying its electronic screen information to said second vehicle according to said second vehicle position; and
whereby said received information by radio signal from said at least first electronic sign increases the capability for updating information outside the reach of an uploading site.
